(19) United States
(12) Patent Application Publication
(10) Pub. No.: US 2009/0096740 A1
(43) Pub. Date: Apr. 16, 2009

(54) Liquid Crystal Display Device and Apparatus and Method for Controlling Luminance of Liquid Crystal Panel Thereof

(75) Inventors: Jian-Tao Xia, Shanghai (CN); Ming-Jie Yu, Shanghai (CN); Tadashi Kubota, Tokyo (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 12/138,508

(22) Filed: Jun. 13, 2008

(30) Foreign Application Priority Data
Oct. 12, 2007 (TW) 096138205

(51) Int. Cl. G09G 3/36

(52) U.S. Cl. 345/102

(57) ABSTRACT

A liquid crystal display device, an apparatus and a method for controlling a luminance of a liquid crystal panel thereof are provided. The liquid crystal display device receives an image signal, generates an image compensating parameter according to the image signal and a plurality of luminance control parameters, and generates a compensated image signal, wherein each luminance control parameters relates to the liquid crystal panel. Then, the control signal is generated according to the image compensating parameter so that the liquid crystal panel displays an image of the compensated image signal. With this device and method, the power consumption of the liquid crystal panel display could be reduced, while the picture quality is preserved.

This application claims the benefit from the priority of Taiwan Patent Application No. 096138205 filed on Oct. 12, 2007, and the disclosures of which are incorporated by reference herein in their entirety.

### CROSS-REFERENCES TO RELATED APPLICATIONS

Not applicable.

### BACKGROUND OF THE INVENTION

1. Field of the Invention

The present invention relates to a liquid crystal display device and an apparatus and a method for controlling the luminance of a liquid crystal panel thereof. More particularly, the present invention relates to a liquid crystal display device and an apparatus and a method for controlling the luminance of a liquid crystal panel thereof by using characteristics of the liquid crystal panel and a received image signal.

2. Descriptions of the Related Art

Liquid crystal displays (LCDs) are widely used in many electric apparatuses, such as LCD TVs, notebooks, mobile phones, digital cameras, personal digital assistants (PDAs), and LCD screens. Since the LCD panel, configured to display images, of an LCD device does not actively emit luminance, it must operate with a backlight module for displaying images.

FIG. 1 illustrates a schematic diagram of a traditional LCD device 10 that is equipped with a backlight module. The apparatus 10 comprises a receiving interface 11, a control signal generating module 12, and a LCD panel 13. The LCD panel 13 comprises an LCD panel unit 131 and a backlight module 132. The control signal generating module 12 may be a micro-controller unit.

The convention method uses the backlight module 132 to generate lights with fixed luminance for lighting up all the pixels of the LCD panel unit 131. From the viewpoint of power consumption, the backlight module 132 does not efficiently provide luminance. For example, when displaying a darker image, the LCD panel unit 131 filters most luminance generated by the backlight module 132. Thus, it wastes electric power generated by the backlight module 132. For many electronic devices, LCD devices consume a huge proportion of the total electric power. For example, the LCD device of an LCD TV consumes about 70% of the electric power. Therefore, if the electric power consumed by the LCD device can be decreased, the lifetime of the electric apparatus can be increased.

U.S. Pat. No. 7,176,878 discloses a method for decreasing the power consumption of an LCD device. The method decreases the electric power required by the backlight module by decreasing the luminance emitted by the backlight module and compensating the luminance of the image. The drawback of this method is that it decreases the luminance emitted by the backlight module and compensates image luminance by using only the characteristics of the image but not the characteristics of the LCD panel. As a result, the quality of the displayed image of this method is worse than the quality of the original one.

According to the above descriptions, the conventional method of decreasing the luminance of the backlight does not maintain the quality of the displayed image. Therefore, it is important to find a method that can decrease the backlight luminance required by the LCD device and maintain the quality of the displayed image.

### SUMMARY OF THE INVENTION

An objective of this invention is to provide a method for controlling luminance of a liquid crystal display (LCD) panel. The LCD panel comprises a backlight module. The method utilizes characteristics of the LCD panel and the received image signal to adjust the luminance of backlight required by the LCD panel for displaying the image. The power consumption required by the LCD panel is decreased, while the quality of the displayed image is maintained.

To achieve the objective, the method comprises the following steps: (a) receiving an image signal; (b) generating an image compensation parameter by using the image signal and a plurality of luminance control parameters, wherein each of the luminance control parameters is related to a luminance emitted from the backlight module, a plurality of image luminance signals, and an image luminance value of each of the image luminance signals under the luminance emitted from the backlight module; (c) generating an image compensation signal corresponding to the image signal by using the image compensation parameter; (d) generating a control signal by using the image compensation parameter, so that the backlight module emits a luminance in response to the control signal to display an image represented by the image compensation signal on the LCD panel.

Another objective of this invention is to provide an apparatus for controlling luminance of an LCD panel comprising a backlight module. The apparatus utilizes characteristics of the LCD panel and the received image signal to adjust the luminance of backlight required by the LCD panel for displaying the image. The power consumption required by the LCD panel is decreased, while the quality of the displayed image is maintained.

To achieve the objective, the apparatus comprises a receiving interface, an image compensation module, and a control signal generating module. The receiving interface is configured for receiving an image signal. The image compensation module is configured for generating an image compensation parameter by using the image signal and a plurality of luminance control parameters. The image compensation module is also configured for generating an image compensation signal corresponding to the image signal by using the image compensation parameter. Each of the luminance control parameters is related to a luminance emitted from the backlight module, a plurality of image luminance signals, and an image luminance value of each of the image luminance signals under the luminance emitted from the backlight module. The control signal generating module is configured for generating a control signal by using the image compensation parameter, so that the backlight module emits a luminance in response to the control signal to display an image represented by the image compensation signal on the LCD panel.

Yet a further objective of this invention is to provide an LCD device. The LCD device utilizes characteristics of its LCD panel and the received image signal to adjust the luminance of backlight required by the LCD panel for displaying the image. The power consumption required by the LCD device is decreased, while the quality of the displayed image is maintained. To achieve the objectives, the LCD device comprises an LCD panel and the aforementioned apparatus for controlling the luminance of LCD panel, and the LCD device executes the aforementioned method for controlling the luminance of the LCD panel.

According to the above descriptions, the present invention provides an LCD device, and an apparatus and a method for controlling luminance of the LCD panel thereof. The present invention can decrease the backlight luminance required by the LCD device when displaying images, decreases the power consumption of the LCD panel, and maintains the quality of the displayed image.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates the schematic diagram of a traditional LCD device;

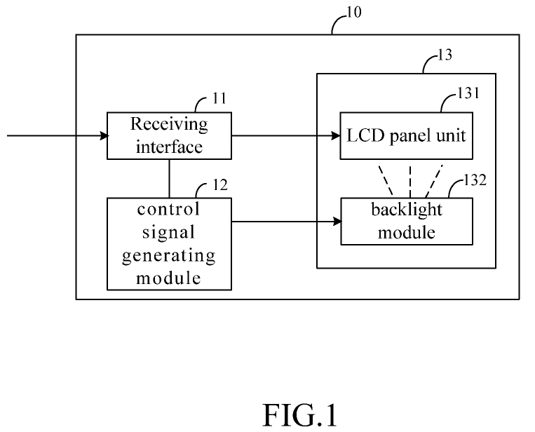

FIG. 2A illustrates a first embodiment of the present invention;

FIG. 2B illustrates a schematic diagram of a testing apparatus that operates with the first embodiment;

FIG. 3A illustrates a flow chart of the application stage of the second embodiment of the present invention;

FIG. 3B illustrates the details of the step 302;

FIG. 4A illustrates a flow chart of the testing stage of the second embodiment of the present invention; and

FIG. 4B illustrates the details of the step 404.

### DESCRIPTION OF THE PREFERRED EMBODIMENT

The following descriptions explain the present invention by some embodiments, which is related to a Liquid Crystal Display (LCD) device, and an apparatus and a method for controlling the luminance of a liquid crystal panel thereof. However, the embodiments of the present invention are not used to limit the present invention to be implemented in any specific environment, applications, and/or specific method. Therefore, the descriptions of the embodiments are used for explanation of the objectives of the present invention but not the limitation of present the invention. It is noted that the elements that are not related to the present invention are omitted in the following embodiments and figures.

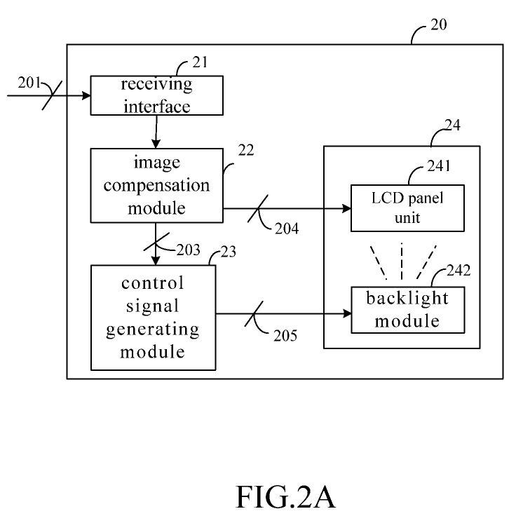

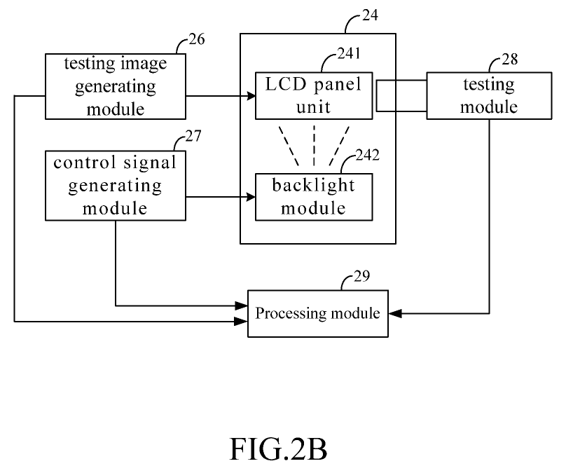

FIG. 2A illustrates a first embodiment of the present invention, which is an LCD device 20. The LCD device 20 comprises a receiving interface 21, an image compensation module 22, a control signal generating module 23, and an LCD panel 24, wherein the LCD panel 24 comprises an LCD panel unit 241 and a backlight module 242.

At first, the receiving interface 21 receives an image signal 201 and transmits the image signal 201 to the image compensation module 22. The image compensation module 22 generates an image compensation parameter 203 by using the image signal 201 and a plurality of luminance control parameters. The image compensation parameter 203 is used by the subsequent processes so that an image indicated by the image signal 201 can be displayed. The luminance control parameters are related to the characteristics of the LCD panel 24. More specific, each of the luminance control parameters is generated by a testing process in advance. Each of the luminance control parameters is related to a luminance emitted from the backlight module 242, a plurality of image luminance signals, and an image luminance value of each of the image luminance signals under the luminance emitted from the backlight module.

The following descriptions comprise two main parts. The first part relates to the testing stage in advance, which generates the luminance control parameters. The second part relates to the application stage, which uses the luminance control parameters; that is the LCD device 20 of this embodiment.

First, the testing apparatus for generating the luminance control parameters is addressed. FIG. 2B illustrates the testing apparatus, which comprises a testing image generating module 26, a control signal generating module 27, a testing module 28, and a processing module 29. The testing apparatus is configured to test the characteristics of the LCD panel 24 (i.e. deriving the luminance control parameters). After the testing, the LCD panel 24 is equipped within the LCD device 20.

The control signal generating module 27 is configured to generate a plurality of testing control signals. In this embodiment, the testing control signals are Pulse Width Modulation (PWM) signals; however, in other embodiments the testing control signals may be in other formats. The backlight module 242 of the LCD panel 24 respectively emits a luminance in response to each of the testing control signals. For each of the testing control signals, the testing image generating module 26 generates a plurality of image luminance signals. To be more specific, 256 image luminance signals are generated for each of the testing control signals, wherein the 256 image luminance signals comprises the image luminance signal whose grey levels are all 0, the image luminance signal whose grey levels are all 1, . . . , and the image luminance signal whose grey levels are all 255.

The testing module 28 generates a relation in response to each of the testing control signal respectively by measuring a testing luminance value displayed on the LCD panel 24 under the corresponding luminance for each of the corresponding image luminance signals. That is, for each of the testing control signals, the testing module 28 measures the luminance values of the 256 image luminance signals displayed on the LCD panel 241. Therefore, the relation for each of the testing control signals is obtained, which is the gamma curve.

After the relation (i.e. gamma curves) for each of the testing control signals has been generated, the processing module 29 generates the luminance control parameters according to the image luminance signals, the testing luminance value, and the corresponding relations. Each of the luminance control parameters corresponds to one of the testing control signals respectively.

The way that the processing module 29 generates the luminance control parameters is described in the following. First, the processing module 29 chooses the largest testing control signal as a standard control signal, and then calculates a luminance variation parameter for each of the testing control signals by the following equation:

$$K ( {P}_{n} ) = \frac{1}{256} {\sum }_{i = 0}^{255} {K}_{i} ( {P}_{n} , {P}_{max} )$$

wherein

$${K}_{i} ( {P}_{n ,} , {P}_{max} ) = \frac{L ( {I}_{i} , {P}_{n} )}{L ( {I}_{i} , {P}_{max} )} ,$$

Iᵢ is an image luminance signal whose gray levels are all i, Pₙ is the n^{th} testing control signal, Pₘₐₓ is the standard control signal (i.e. the largest testing control signal), and L(Iᵢ,Pₙ) and L(Iᵢ,Pₘₐₓ) respectively represents a luminance of the image luminance signal Iᵢ shown on the LCD panel 24 by the luminance from the backlight module 242 driven by the testing control signals Pₙ and Pₘₐₓ. Kᵢ(Pₙ, Pₘₐₓ) is the variation ratio of the luminance of the inverse image of grey level i shown on the LCD panel 24 when the testing control signal is adjusted from Pₘₐₓ to Pₙ. The K(Pₙ) is the average value of Kᵢ(Pₙ, Pₘₐₓ) for i equaling to 0 to 255. The number of the K(Pₙ) calculated by the processing module 29 is the same as the number of the testing control signals. The processing module 29 then normalizes these K(Pₙ) to derive the luminance variation parameter of the testing control signal Pₙ to the standard control signal. That is, the variation degree of the luminance of the LCD panel 24, when adjusting from the largest testing control signal to the testing control signal Pₙ.

Then, processing module 29 calculates a correction value of the LCD panel 24 by using the relation (i.e. the gamma curves) of each of the testing control signals. The correction value is the gamma value of the LCD panel 24. Most electronic optical characteristic of the LCD panel 24 can be represented by the following equation:

Lᵢ=α·(Iᵢ)^{γ},i=0,1,Λ,255

Wherein Lᵢ is the luminance of the LCD panel 24, α is a fixed coefficient of the LCD panel 24, Iᵢ is a grey level of input image signal, and γ is the gamma value of the LCD panel 24. The gamma value γ of the LCD panel 24 is usually a constant. By using the relation (i.e. gamma curve) of each of the testing control signals, the corresponding gamma value can be estimated by curve fitting method. The average value of the gamma values γ is the gamma value of the LCD panel 24. The curve fitting method is well-known in this technical field, so it is not detailed here.

At last, the processing module 29 generates the luminance control parameter for each of the testing control signals. Since the variation of the testing control signals will have influence on the luminance of the LCD panel 24, the luminance of the LCD panel 24 should be compensated by a luminance control parameter H so that the luminance of the image displayed on the LCD panel 24 is equal to the original luminance. The equation L(I,1)=α·(I)^{γ} expresses the luminance of the image when the luminance of the backlight module 242 is the brightest, wherein γ is the gamma value of the LCD panel 24, α is the fixed coefficient of the LCD panel 24, and I represent the input image. If the testing control signal is decreased to p and the luminance of the input image is compensated by the luminance control parameter H, then the final luminance of the image on the LCD panel 24 can expressed by the following equation:

\tilde{L}=K(p)·α·(H·I)^{γ}

To maintain the image quality after adjusting the testing control signal (that is, to compensate the image to have the luminance of L=L(I,1), the corresponding luminance control parameter is generated for each of the testing control signals. Their relation can be expressed by the following equation:

$$H = {( \frac{1}{K ( p )} )}^{1 / γ}$$

The second part (i.e. the application stage) is now described, which is the first embodiment of the present invention. To be more specific, the application stage is to adjust the image to be displayed and the control signal according to the characteristics of the LCD panel 24.

More specifically, after the receiving interface 21 receives the image signal 201, the image compensation module 22 utilizes the image signal 201 and the luminance control parameters to generate the image compensation parameter 203. More specifically, the image compensation module 22 generates a first compensation coefficient by dividing 255 by the maximal luminance value Sₘₐₓ of the image signal 201; that is, generates 255/Sₘₐₓ. The image compensation module 22 chooses the largest luminance control parameter as a second compensation coefficient Hₘₐₓ. According to the above method for generating the luminance control parameters, the largest luminance control parameter corresponds to the smallest testing control signal. The image compensation module 22 chooses the smaller one from the first compensation coefficient and the second compensation coefficient as the image compensation parameter 203. According to the aforementioned description, it is understood that the image compensation parameter 203 relates to the image signal 201 and the characteristics of the LCD panel 24.

Then, the image compensation module 22 generates a image compensation signal 204 corresponding to the image signal 201 by using the image compensation parameter 203. To be more specific, image compensation signal 204 is equal to the multiplication of the image signal 201 and the image compensation parameter 203. The image compensation signal 204 is transmitted to the LCD panel unit 241 of the LCD panel 24. Meantime, the image compensation parameter 203 is transmitted to the control signal generating module 23. The control signal generating module 23 generates a control signal 205 by the image compensation parameter 203. The control signal generating module 23 is a luminance control signal generator of a backlight module 242, and the control signal 205 is a luminance control signal of the backlight module 242. Furthermore, the luminance control signal generator of the backlight module 242 may be a pulse width modulation signal generator and the luminance control signal of the backlight module 242 may be a pulse width modulation signal.

It is noted that in the aforementioned testing stage for generating the luminance control parameters, a testing control signal is respectively derived for each of the luminance control parameter. Therefore, the control signal 205 which corresponds to the image compensation parameter 203 can be generated according to the relation.

At last, the control signal 205 is transmitted to the backlight module 242, so that the backlight module 242 emits a luminance in response to the control signal 205 to display an image represented by the image compensation signal 204 (i.e. an image represented by the image signal 201) on the LCD panel unit 241.

The LCD device 20 of this embodiment decides the image compensation parameter 203 and the control signal 205 according to the received image signal 201 and the characteristics of the LCD panel 24. On the one hand, it decreases the intensity of the control signal 205 so that the luminance emitted from the backlight module of the LCD panel 24 is decreased. On the other hand, the quality of the displayed image is maintained by using the image compensation signal 204 generated by the image compensation parameter 203. Therefore, the power consumption of the LCD device 20 is reduced, while the image quality is maintained.

The second embodiment of the present invention is a method for controlling the luminance of an LCD panel comprising a backlight module. The method can be used in the LCD device 20 illustrated in FIG. 2A.

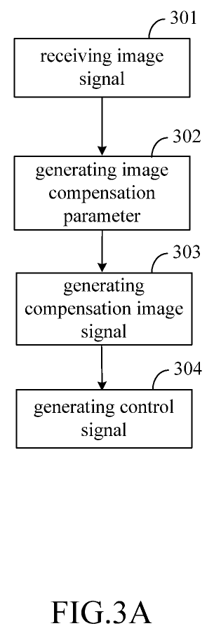

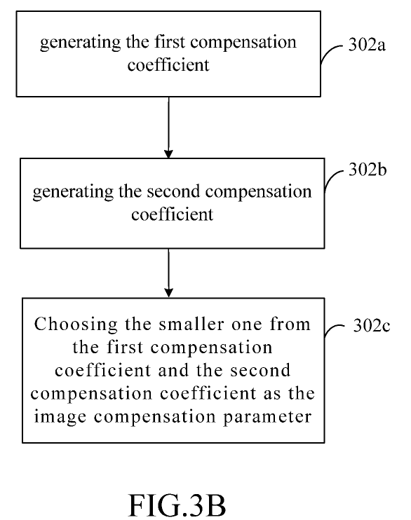

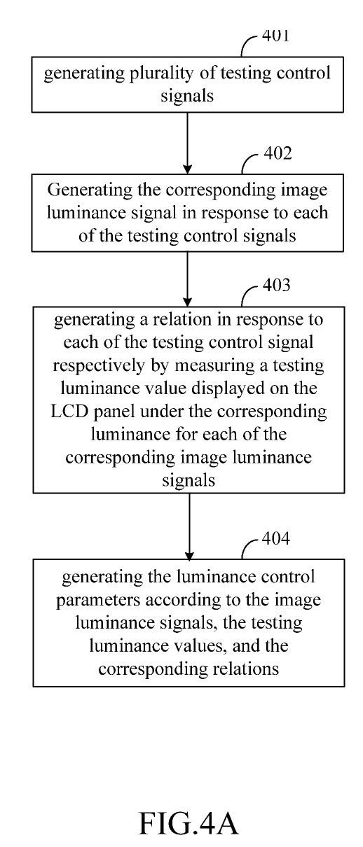

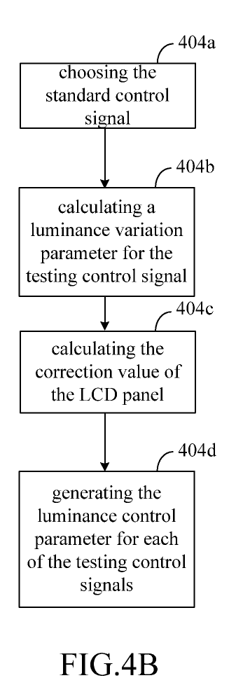

Please refer to FIGS. 3A, 3B, 4A, and 4B. FIG. 3A illustrates a flow chart of the application stage of the second embodiment, which is a method for controlling the luminance of an LCD panel. At first, step 301 is executed for the receiving interface 21 to receive an image signal 201. Then, the image compensation module 22 executes step 302 to generate an image compensation parameter 203 by using the image signal and a plurality of luminance control parameters, wherein each of the luminance control parameters is related to the characteristic of the LCD panel 24. More specifically, each of the luminance control parameters is related to a luminance emitted from the backlight module 242, a plurality of image luminance signals of the LCD panel, and an image luminance value of the image luminance signals under the luminance emitted from the backlight module. The luminance control parameters are generated in advanced, and the flow chart of the process will be described later. It is now assumed that the luminance control parameters have been generated.

FIG. 3B illustrates the details of the step 302. Step 302a is first executed to generate a first compensation coefficient by using a maximal luminance value of the image signal 201. Then, step 302b is executed to choose the largest luminance control parameter as a second compensation coefficient. According to the aforementioned method for generating the luminance control parameters, the largest luminance control parameter corresponds to the smallest testing control signal. Step 302c is executed thereafter to choose the smaller one from the first compensation coefficient and the second compensation coefficient as the image compensation parameter 203. According to the above description, it is known that the image compensation parameter 203 relates to the characteristic of the image signal 201 and the LCD panel 24.

After the generation of the compensation parameter 203, the step 303 is executed. The image compensation module 22 generates the image compensation signal 204 corresponding to the image signal 201 by using the image compensation parameter 203. More specifically, the image compensation signal 204 is generated by multiplying the image signal 201 by the image compensation parameter 203. The image compensation signal 204 comprises the image to be displayed on the LCD panel unit 241. Finally, step 304 is executed, in which the control signal generating module 23 generates a control signal 205 by using the image compensation parameter 203, so that the backlight module 242 emits a luminance in response to the control signal 205 to display the image represented by the image compensation signal 204 on the LCD panel 24.

Then, the method for generating the luminance control parameters is described, whose flow chart is illustrated in FIG. 4. First, step 401 is executed, in which a plurality of testing control signals are generated. The testing control signals are pulse width modulation signals, and the backlight module 242 emits a corresponding luminance in response to each of the testing control signals respectively. Then, step 402 is executed to generate the image luminance signal in response to each of the testing control signals. That is, 256 image luminance signals are generated for each of the testing control signals, wherein the 256 image luminance signals comprises the image luminance signal whose grey levels are all 0, 1, 2, . . . , 255.

Step 403 is executed to generate a relation in response to each of the testing control signal respectively by measuring a testing luminance value displayed on the LCD panel under the corresponding luminance for each of the corresponding image luminance signals. More specifically, for each of the testing control signals, the 256 image luminance signals correspond to 256 measured luminances. Thus, each of the testing control signals has a relation regarding the measured luminance of the LCD panel 24 and the image luminance signals. The relation is a gamma curve.

Next, the step 404 is executed to generate the luminance control parameters according to the image luminance signals, the testing luminance values, and the corresponding relation, wherein each of the luminance control parameters corresponds to one of the testing control signals respectively.

The flow chart in FIG. 4B illustrates the details of the step 404. At first, step 404a is executed to choose the largest testing control signal as a standard control signal. Then, the step 404b is executed to calculate a luminance variation parameter for each testing control signal by using the corresponding testing luminance values and the testing luminance values corresponding to the standard control signal. The generation of the luminance variation parameter is the same as that described in the first embodiment, so it is not repeated here.

Step 404c is executed to calculate a correction value of the LCD panel 24 by using the relations of the testing control signals. The correction value is a gamma value of the LCD panel 24. The generation method of the gamma value is the same as that in the first embodiment, so it is not repeated here. At last, step 404d is executed to generate the luminance control parameter for each of the testing control signal by using the correction value and the corresponding luminance variation parameter. The generation method is the same as that described in the first embodiment, so it is not repeated here.

The method for controlling luminance of the LCD panel in this embodiment utilizes characteristics of the received image signal and the LCD panel. In addition to decreasing the intensity of the control signal, the method compensates for the luminance of the image so that the quality of the displayed image can be maintained.

According to the above descriptions, the invention provides an LCD device, and an apparatus and a method for controlling luminance of an LCD panel comprising a backlight module. By the present invention, the luminance control parameters generated according to the characteristics of the LCD panel in advance and the characteristics of the received image signal provide suitable control signal, so as to decrease luminance of the backlight module and compensate the luminance of the image in order to maintain the image quality. Compare to the prior art (i.e. decreasing the luminance of the backlight module and compensate the parameter of the image luminance by using only the characteristics of image signal), the present invention maintains the image quality.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A method for controlling luminance of a liquid crystal display (LCD) panel comprising a backlight module, comprising the steps of:
(a) receiving an image signal;
(b) generating an image compensation parameter by using the image signal and a plurality of luminance control parameters, wherein each of the luminance control parameters is related to a luminance emitted from the backlight module, a plurality of image luminance signals, and an image luminance value of each of the image luminance signals under the luminance emitted from the backlight module;
(c) generating an image compensation signal corresponding to the image signal by using the image compensation parameter; and
(d) generating a control signal by using the image compensation parameter, so that the backlight module emits a luminance in response to the control signal to display an image represented by the image compensation signal on the LCD panel.

2. The method of claim 1, wherein the step (b) comprises the steps of:
(b1) generating a first compensation coefficient by using a maximal luminance value of the image signal;
(b2) choosing the largest luminance control parameter as a second compensation coefficient; and
(b3) choosing the smaller one from the first compensation coefficient and the second compensation coefficient as the image compensation parameter.

3. The method of claim 1, wherein the step (c) multiplies the image compensation parameter by the image signal to generate the image compensation signal.

4. The method of claim 1, wherein the control signal is a pulse width modulation signal.

5. The method of claim 1, further comprising the steps of:
(e) generating a plurality of testing control signals, so that the backlight module emits a luminance in response to each of the testing control signals respectively;
(f) generating the corresponding image luminance signal in response to each of the testing control signals;
(g) generating a relation in response to each of the testing control signal respectively by measuring a testing luminance value displayed on the LCD panel under the corresponding luminance for each of the corresponding image luminance signals; and
(h) generating the luminance control parameters according to the image luminance signals, the testing luminance values, and the corresponding relations, wherein each of the luminance control parameters corresponds to one of the testing control signals respectively.

6. The method of claim 5, wherein the step (h) comprises the steps of:
(h1) choosing the largest testing control signal as a standard control signal;
(h2) calculating a luminance variation parameter for each of the testing control signals by using the corresponding testing luminance values and the testing luminance values corresponding to the standard control signal;
(h3) calculating a correction value of the LCD panel by using the relations; and
(h4) generating the luminance control parameter for each of the testing control signals by using the corresponding luminance variation parameter and the correction value of the LCD panel.

7. The method of claim 6, wherein each of the relations is a gamma curve and the correction value is a gamma value.

8. An apparatus for controlling luminance of an LCD panel comprising a backlight module, comprising:
a receiving interface for receiving an image signal;
an image compensation module for generating an image compensation parameter by using the image signal and a plurality of luminance control parameters and for generating an image compensation signal corresponding to the image signal by using the image compensation parameter, wherein each of the luminance control parameters is related to a luminance emitted from the backlight module, a plurality of image luminance signals, and an image luminance value of each of the image luminance signals under the luminance emitted from the backlight module;
a control signal generating module for generating a control signal by using the image compensation parameter, so that the backlight module emits a luminance in response to the control signal to display an image represented by the image compensation signal on the LCD panel.

9. The apparatus of claim 8, wherein the control signal generating module is a luminance control signal generator of the backlight module and the control signal is a luminance control signal of the backlight module.

10. The apparatus of claim 9, wherein the luminance control signal generator of the backlight module is a pulse width modulation signal generator and the luminance control signal of the backlight module is a pulse width modulation signal.

11. The apparatus of claim 8, wherein the image compensation module generates a first compensation coefficient by using a maximal luminance value of the image signal, chooses the largest luminance control parameter as a second compensation coefficient, and chooses the smaller one from the first compensation coefficient and the second compensation coefficient as the image compensation parameter.

12. The apparatus of claim 8, wherein the image compensation module multiplies the image compensation parameter by the image signal to generate the image compensation signal.

13. An LCD device, comprising:
an LCD panel, comprising a backlight module;
a receiving interface for receiving an image signal;
an image compensation module for generating an image compensation parameter by using the image signal and a plurality of luminance control parameters and for generating an image compensation signal corresponding to the image signal by using the image compensation parameter, wherein each of the luminance control parameters is related to a luminance emitted from the backlight module, a plurality of image luminance signals, and an image luminance value of each of the image luminance signals under the luminance emitted from the backlight module;
a control signal generating module for generating a control signal by using the image compensation parameter, so that the backlight module emits a luminance in response to the control signal to display an image represented by the image compensation signal on the LCD panel.

14. The LCD device of claim 13, wherein the control signal generating module is a luminance control signal generator of the backlight module and the control signal is a luminance control signal of the backlight module.

15. The liquid display device of claim 14, wherein the luminance control signal generator of the backlight module is a pulse width modulation signal generator and the luminance control signal of the backlight module is a pulse width modulation signal.

16. The liquid display device of claim 13, wherein the image compensation module generates a first compensation coefficient by using a maximal luminance value of the image signal, chooses the largest luminance control parameter as a second compensation coefficient, and chooses the smaller one from the first compensation coefficient and the second compensation coefficient as the image compensation parameter.

17. The liquid display device of claim 13, wherein the image compensation module multiplies the image compensation parameter by the image signal to generate the image compensation signal.
